(19) United States
(12) Patent Application Publication
(10) Pub. No.: US 2007/0282504 A1
(43) Pub. Date: Dec. 6, 2007

(54) Parking Assistance

(75) Inventors: Stefan Luke, Olpe (DE); Maxim Arbitmann, Rochester Hills, MI (US)

Correspondence Address: Gerlinde Nattler;Continental Teves Inc, One Continental Drive, Auburn Hills, MI, 48326, US

(73) Assignee: Continental Teves AG & Co. oHG

(21) Appl. No.: 10/591,265

(22) PCT Filed: Feb. 25, 2005
(86) PCT No.: PCT/EP05/50822

§ 371 Date: Jul. 12, 2007

(30) Foreign Application Priority Data
Mar. 5, 2004 (DE) 10 2004 011 407.2
Feb. 16, 2005 (DE) 10 2005 006 965.7

(51) Int. Cl. B62D 6/00

(52) U.S. Cl. 701/44

(57) ABSTRACT

With a parking assistance system for a vehicle, in which autonomous driving or steering of the vehicle on a path for maneuvering into a parking space is make possible or a driver of the vehicle is assisted in a parking maneuver on the path for parking in the parking space by means of a steering torque applied to the steering wheel, whereby the driver is guided by at least one artificial steering stop, preferably one or two artificial steering stops, on the path for driving into the parking space, and the parking space is measured by a lateral distance measurement and the position is determined from signals from wheel rpm sensors and a steering angle sensor.

### BACKGROUND OF THE INVENTION

The invention relates to a parking assistance for a vehicle.

The invention also relates to a parking space measuring module for a vehicle.

The invention also relates to a method for measuring a parking space for a vehicle.

The object of this invention is to create a parking assistance and a parking space measuring module as well as a method that will permit measurement of a parking space, in particular for automatic driving or steering of the vehicle or assisting the driver during his steering activity in maneuvering into a parking space in a relatively simple and convenient manner.

### SUMMARY OF THE INVENTION

This object is achieved by a parking assistance for a vehicle which is characterized in that the parking assistance permits autonomous driving or steering with a vehicle on a path for maneuvering into a parking space or assists a driver of a vehicle in a parking maneuver on the path for maneuvering into the parking space by means of a steering torque applied to the steering wheel, whereby the driver is guided into the parking space by at least one artificial steering stop, preferably one or two artificial steering stops on the path for maneuvering into the parking space, and the parking space is measured by means of a lateral distance measurement and a determination of position for the signals of wheel rpm sensors and a steering angle sensor.

In one embodiment according to this invention, convenient instructions are given to the driver by means of haptic feedback. In doing so, it remains ensured that the driver will implement or intentionally agree with the instructions while parking.

In an alternative embodiment according to this invention, the vehicle is automatically steered on a certain path into a parking gap.

This object is achieved by a parking space measuring module for a vehicle, in particular for a parking assistance according to this invention, whereby a parking space is measured by means of a lateral distance measurement and a position determination from signals from wheel rpm sensors and a steering angle sensor.

This object is achieved by a method for measuring a parking space for a vehicle, in particular for a parking assistance according to this invention, which is characterized in that measurement of the parking space is performed by a lateral distance measurement and a position determination from a steering angle, preferably a steering angle measured by a steering angle sensor, and a path change information, preferably a path measured on the basis of wheel rpm sensors.

This invention is used in particular for measuring a parking space for parking in reverse, where the parking space is recognized and measured via the sensor signals as the vehicle passes by the parking space.

According to this invention, the parking space is measured by dividing the process into the following steps:
a rough recognition of corners of the objects or vehicles bordering the parking space, in particular the corners of the vehicles in front of and behind the parking space,
a determination of valid ranges for fronts of the objects or vehicles bordering the parking space, in particular the vehicle corners in front of and behind the parking space,
a determination of the fronts of the objects or vehicles bordering the parking space, in particular the vehicle fronts in front of and behind the parking space,
a calculation of the corners of the objects or vehicles bordering the parking space, in particular the corners of the vehicles in front of and behind the parking space from these valid ranges.

This means that tolerance ranges are defined after an initially approximate detection of the parking space. Then the front of the vehicle is aligned (linear equation). Next a deviation in the measured signals from the determined signals is determined. Depending on the deviations, the corner positions have been determined. Finally the parking space is determined and/or measured, i.e., its size and position in relation to the vehicle to be parked are determined.

According to this invention, the signals of the wheel rpm sensors are interrupt signals of the rear wheel rpm sensors of the wheels of a rear axle (rear wheels) and, depending on the extent of these signals, which are preferably averaged, a path change of the rear axle midpoint is determined, in particular with regard to a Cartesian coordinate system.

According to this invention, a Cartesian coordinate system is defined as a “lower” Cartesian coordinate system in an initialization phase for a parking procedure.

According to this invention, path change of the midpoint of the rear axle of the vehicle and a steering angle □_{actual} measured by the steering angle sensor for a continuous determination of position and yaw angle (Ψ) is calculated in relation to a coordinate system set at the start.

According to this invention a current position of the vehicle is determined in the following steps:
Determining a distance □s by which the vehicle has moved since the last scanning step on the basis of wheel rpm sensor signals a scaling factor,
Calculating the yaw angle Ψ_{actual} of the vehicle on the basis of the distance determined Δs, the steering angle sensor signals and the wheel base 1 of the vehicle,
Determining the current yaw angle Ψ_{actual} by means of these a cursive equation
   [insert]
Determining the current actual x position x_{actual} and actual y position y_{actual} of the rear axle midpoint from the current yaw angle and current steering angle.

According to this invention, an x-y position of the object surfaces bordering the parking space is calculated in relation to a global coordinate system on the basis of a continuously determined position and a continuously determined yaw angle (Ψ) in relation to a coordinate system set at the start and a distance d from the lateral distance measurement.

According to this invention, recognition of the parking space and/or the object surfaces bordering the parking space is performed independently of stored values or intermediate values essentially only on the basis of a change in a distance d from the lateral distance measurement.

According to this invention, measured values and/or sensor signals of the lateral distance measurement and/or position determination are at least partially filtered.

According to this invention, a (global) Cartesian coordinate system is defined for a parking operation and a tolerance range for the x coordinate is preselected or determined as a function of jumps in the distance value d at the beginning of the parking space and at the end of the parking in which a corner of the objects or vehicles bordering the parking space could lie.

According to this invention, fronts of the vehicles bordering the parking space (vehicle fronts in front of and behind the parking space) are determined from the measured values and the values outside of the tolerance range (i.e., without the values in the tolerance ranges) and the vehicle fronts of the vehicle in front and the vehicle in the back are described as a linear equation, whereby these equations are each preferably determined by the method of the least error squares.

According to this invention, the exact exposition at the corner is determined from the deviations in the measured values from the straight lines determined. Then the X coordinate of the corner thus found is inserted into the linear equation to determine the Y position of the corner.

According to this invention, the fronts of the vehicles bordering the parking space (vehicle fronts in front of and behind the parking space) are determined and a shape of a driving path border (curb) is deduced from the vehicle fronts thereby determined.

According to this invention, determining the parking space includes the following steps:
Waiting for first parking space corner
Passing the first parking space corner
Defining a tolerance range for the first parking space corner
Defining a range for a first vehicle front
Calculating a linear equation for the first vehicle front
Waiting for a second parking space corner
Calculating the first corner
Passing the second corner
Defining a tolerance range for the second parking space corner
Waiting on a valid starting range for a parking maneuver
Defining the valid range for a second vehicle front
Continuous calculation of the linear equation for the second vehicle front
Continuous calculation of the second corner
Calculating the forward trajectory (forward path)

The invention will now be illustrated in greater detail as an example on the basis of an exemplary embodiment and figures (FIG. 1 and FIG. 2).

### BRIEF DESCRIPTION OF THE DRAWINGS

In the figures:

FIG. 1 shows the geometric relationships and position parameters for calculating the path into a parking space.

FIG. 2 shows schematically a parking space and a vehicle to be parked therein in the measurement of the parking space.

### DETAILED DESCRIPTION OF THE DRAWINGS

According to this invention, signals from the wheel rpm sensors, preferably the interrupt signals of the rear wheel rpm sensors (Wheel_Interrupts_RL and Wheel_Interrupts_RR) are used to determine a change in path of the rear axle head point in relation to a global Cartesian coordinate system.

The observed wheel rpm sensor signals are averaged for this purpose.

The global Cartesian coordinate system is defined in an initialization phase for the entire algorithm.

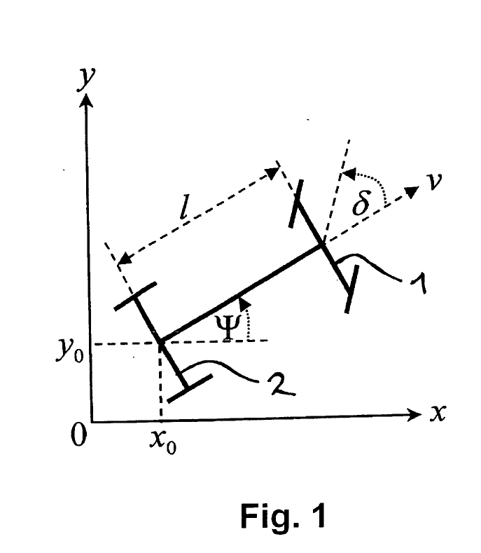

The path, i.e., the change in path of the rear axle midpoint is calculated together with the measured steering angle □_{actual} (rad) by a steering angle sensor for continuous determination of position and yaw angle (Ψ) in relation to a coordinate system set at the start. This situation is depicted in FIG. 1 which shows the coordinate system (x and y axis), a vehicle depicted schematically with a steerable front axle 1 and rear axle 2, which are shown at the beginning here in an x₀/y₀ rear axle position.

The current position of the vehicle is advantageously determined with the help of three recursive equations.

First with the help of the wheel rpm sensor signals and a scaling factor (scaling factor Mm_per_{—}100_teeth) the distance Δs, is calculated preferably in units of cm by which the vehicle has moved since the last scanning step, here in particular a last program run-through of a regulating program (the last software loop).

$$Δ s = \frac{\begin{matrix}Wheel\_interrupts \_RR + \\ Wheel\_interrupts \_RL\end{matrix}}{2} * Mm\_per \_ 100 \_teeth \qquad ( 1 )$$

If this distance is known, then with the help of the steering angle on the wheel and the wheel base 1 of the vehicle (see FIG. 1), the yaw angle Ψ_{actual} of the vehicle is calculated.

The new yaw angle is obtained from the following recursive formula:

$${Ψ}_{ist} ( k + 1 ) = {Ψ}_{ist} ( k ) + \frac{Δ s}{l} * sin ( {δ}_{ist} ) \qquad ( 2 )$$

Now the current actual x position x_{actual} and the actual y position y_{actual} of the rear axle midpoint can be determined from the yaw angle and the steering angle:
xᵢₛₜ(k+1)=xᵢₛₜ(k)+Δs*cos(δᵢₛₜ(k))*cos(Ψᵢₛₜ(k+1)) (3)
yᵢₛₜ(k+1)=yᵢₛₜ(k)+Δs*cos(δᵢₛₜ(k))*sin(Ψᵢₛₜ(k+1)) (4)

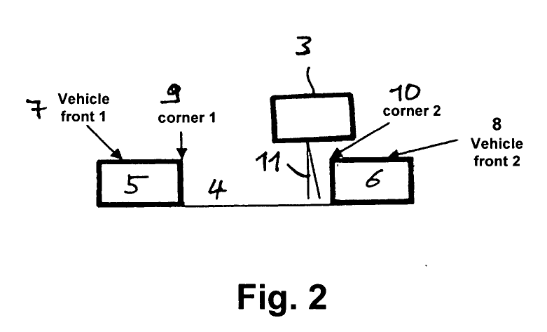

With this position information, the parking space can be measured by a laterally oriented sensor (see FIG. 2).

In FIG. 2 a vehicle 3 drives past a parking space 4 which is bordered by two vehicles 5, 6 and/or their vehicle fronts 7, 8 and vehicle corners 9, 10. The vehicle 3 has a sensor which can detect a lateral distance, represented here by a sensor beam 11.

The x-y position of the object surfaces detected can be calculated in relation to the global coordinate system from the distance d measured laterally together with the change in position of the rear axle midpoint and the yaw angle Ψ.

If there are multiple measured y values for one x value, then these values are averaged or the y value extending the farthest into the path of the vehicle (worst case) is the value used.

The parking space corners are detected independently of these stored values merely on the basis of the change in the distance d measured by the sensor.

In order for individual “false” measured values (freak values) not to be recognized as corners, there is a filtering, in particular only “weak” filtering of the signal to smooth out the freak values. At the same time, there is also filtering of the signal, in particular a “strong” filtering to smooth out the actual corners. The difference between these signals corresponds to the recognition quality of the corners and is compared with a threshold value. On exceeding the threshold value, it is assumed that a corner has been passed.

A tolerance range for the x coordinate within which the corner could be situated is assumed about the recognized corner position. The calculated positions of the object surface measured in a defined x range in front of the tolerance range of the first corner are then considered part of the first vehicle front.

The data between the two corner areas is counted by analogy with the parking space which starts after the second corner to the second vehicle front.

On the basis of the recognized ranges vehicle front 1,7, parking space 4, vehicle front 2,8 the coordinates of the parking space can then be calculated from the stored measured data.

The vehicle fronts of the vehicle in front and the vehicle behind are described in simplified terms as a linear equation. These equations are preferably determined by the method of least error squares.

The deviation in the measured y coordinates from the vehicle front linear equations in the tolerance range is averaged and used to obtain information about the beginning and end of the parking space.

When a deviation threshold is exceeded, the two x coordinates x_{edge1}, x_{edge2} of the parking space corners are each determined. The y coordinates of the two parking space corners y_{edge1}, y_{edge2} are calculated by inserting x_{edge1}, x_{edge2} into the respective equations of the vehicle fronts.

To better distribute an available computation power over the entire measurement process, it is divided among the following states:
Waiting for first parking space corner
Passing the first parking space corner
Defining a tolerance range for the first parking space corner
Defining the range for the first vehicle front
Calculating a linear equation for the first vehicle front
Waiting for a second parking space corner
Calculating the first corner
Waiting for the second parking space corner
Defining the tolerance range for the second parking space corner
Waiting for the valid starting range for the parking maneuver
Defining the valid range for the second vehicle front
Continuous calculation of the linear equation for the second vehicle front
Calculation of the linear equation
Continuous calculation of the second corner
Calculation of the forward trajectory

The forward parking trajectory (forward path) may be calculated once without further measurements. Further measurements during the parking operation may be utilized to update the calculation of the second vehicle front. In this case however recalculation of the trajectory (path) is necessary.

This method also offers the advantage of omitting a curb measurement. In this case, the curb is deduced from the vehicle fronts 7, 8.

1-16. (canceled)

17. A parking assistance device for a vehicle comprising:
a parking assistance unit that permits autonomous parking or steering of the vehicle on a path for parking or assists a driver of the vehicle in a parking operation on the path for parking the vehicle by applying a steering torque to a steering wheel, wherein the driver is guided by at least one artificial steering stop on the path for parking the vehicle, and a measurement of a parking space is performed by a lateral distance measurement and a determination of position from signals from wheel rpm sensors and a steering angle sensor.

18. A method for measuring a parking space comprising:
measuring a lateral distance of the parking space; and
determining a position based on a steering angle and a change in path information, wherein the change in path information is determined based on signals from wheel rpm sensors.

19. A method according to claim 18 further comprising:
approximately detecting corners of objects or vehicles bordering the parking space;
determining valid ranges for fronts of the objects or vehicles bordering the parking space;
determining the fronts of the objects or vehicles bordering the parking space; and
calculating the corners of the objects or vehicles bordering the parking space from the valid ranges.

20. A method according to claim 18, wherein the signals of the wheel rpm sensors are interrupt signals of the rear wheel rpm sensors of the wheels on the rear axle, and depending on these signals, a change in path of the rear axle midpoint is determined.

21. A method according to claim 20, wherein a Cartesian coordinate system is defined as a “global” Cartesian coordinate system in an initialization phase for a parking procedure.

22. A method according to claim 18, wherein a change in path of the rear axle midpoint of the vehicle and a steering angle measured by the steering angle sensor are calculated for a continuous determination of position and yaw angle in relation to a coordinate system sent at the start.

23. A method according to claim 18 further comprising determining a current vehicle position by:
determining a distance Δs by which the vehicle has moved since a last scanning step on the basis of the wheel rpm sensor signals and a scaling factor;
calculating a yaw angle of the vehicle on the basis of the distance Δs determined, the steering angle sensor signals and a wheel base of the vehicle;
determining a particular current yaw angle by a recursive equation
$${Ψ}_{ist} ( k + 1 ) = {Ψ}_{ist} ( k ) + \frac{Δ s}{l} * sin ( {δ}_{ist} )$$
and;
determining a current actual x position and actual y position of a rear axle midpoint from the current yaw angle and the current steering angle.

24. A method according to claim 18, wherein on the basis of a continuously determined position and a continuously determined yaw angle in relation to a coordinate system set at the start and a distance d from the lateral distance measurement, an x-y position of the object surfaces bordering the parking space is calculated in relation to a global coordinate system.

25. A method according to claim 18, wherein the detection of the parking space or the object surfaces bordering the parking space is performed independently of stored values or interim values on the basis of a change in a distance d from the lateral distance measurement.

26. A method according to claim 18, wherein at least one of measured values or sensor signals of the lateral distance measurement or position determination is at least partially filtered.

27. A method according to claim 18, wherein a Cartesian coordinate system for a parking operation is defined and a tolerance range for the x coordinate, in which a corner of the objects or vehicles bordering the parking space could be situated, is preselected or determined as a function of jumps in the distance value d at the beginning of the parking space and at the end of the parking space.

28. A method according to claim 18, wherein fronts of the vehicles bordering the parking space (vehicle fronts in front of and behind the parking space) are determined from the measured values that are outside of the tolerance range and the vehicle fronts of the vehicles in front and behind are described in simplified terms by a linear equation.

29. A method according to claim 28, wherein an exact x position of the corner is determined from the deviations and the measured values from the straight lines thus determined.

30. A method according to claim 18, wherein fronts of the vehicles bordering the parking space (vehicle fronts in front of and behind the parking space) are determined and a shape of the border of the path is deduced from the determined vehicle fronts.

31. A method according to claim 18 further comprising:
waiting for a first parking space corner;
passing the first parking space corner;
defining a tolerance range for the first parking space corner;
defining a range for a first vehicle front;
calculating a linear equation for the first vehicle front;
waiting for a second parking space corner;
calculating the first corner;
passing the second corner;
defining a tolerance range for the second parking space corner;
waiting on a valid starting range for a parking maneuver;
defining the valid range for a second vehicle front;
continuously calculating a linear equation for the second vehicle front;
continuously calculating the second corner; and
calculating a forward trajectory.
